(19) United States
(12) Patent Application Publication
(10) Pub. No.: US 2025/0112493 A1
(43) Pub. Date: Apr. 3, 2025

(54) METHOD AND APPARATUS FOR PRECHARGING DC-LINK CAPACITOR IN HIGH-VOLTAGE DC DISTRIBUTION SYSTEM

(71) Applicant: Microchip Technology Incorporated, Chandler, AZ (US)

(72) Inventors: Ehab Tarmoom, Allen Park, MI (US); Dennis Meyer, Chandler, AZ (US); Steven Chenetz, Gilbert, AZ (US)

(73) Assignee: Microchip Technology Incorporated, Chandler, AZ (US)

(21) Appl. No.: 18/901,660

(22) Filed: Sep. 30, 2024

Related U.S. Application Data
(60) Provisional application No. 63/541,248, filed on Sep. 28, 2023.

(51) Int. Cl. H02J 7/34; B60L 1/00; B60L 1/02; H02J 7/00

(52) U.S. Cl. CPC H02J 7/345; B60L 1/003; B60L 1/02; H02J 7/00304; H02J 7/00308; B60L 2210/10; H02J 2207/50

(57) ABSTRACT

A pre-charging circuit for charging a DC-link capacitor is provided. The pre-charging circuit may include a first semiconductor switch to be coupled to a first terminal of a high voltage source, a first inductor to be coupled to the first semiconductor switch and a first terminal of a capacitor, a second semiconductor switch to be coupled to a second terminal of the high voltage source, a second inductor to be coupled to the second semiconductor switch and a second terminal of the capacitor, and a diode coupled to the first semiconductor switch, the second semiconductor switch, the first inductor, and the second inductor, and coupled in parallel with the capacitor.

### CROSS-REFERENCE TO RELATED APPLICATION

The present application claims priority to U.S. Provisional Patent Application No. 63/541,248, entitled: Method and Apparatus for Pre-Charging DC-Link Capacitor In High-Voltage DC Distribution System, filed on Sep. 28, 2023, the contents of which are hereby incorporated by reference in their entirety.

### TECHNICAL FIELD

The present disclosure relates generally to pre-charging a DC-link capacitor, and more specifically to pre-charging a DC-link capacitor using a pre-charging circuit that does not require a resistor.

### SUMMARY

According to an aspect of one or more examples, there is provided a pre-charging circuit that may include a first semiconductor switch to be coupled to a first terminal of a high voltage source, a first inductor to be coupled to the first semiconductor switch and a first terminal of a capacitor, a second semiconductor switch to be coupled to a second terminal of the high voltage source, a second inductor to be coupled to the second semiconductor switch and a second terminal of the capacitor, and a diode coupled to the first semiconductor switch, the second semiconductor switch, the first inductor, and the second inductor, and coupled in parallel with the capacitor. At least one of the first inductor and the second inductor may be a wiring parasitic inductance. The pre-charging circuit may also include a first gate driver circuit to drive the first semiconductor switch, and a second gate driver circuit to drive the second semiconductor switch. The pre-charging circuit may also include an RC snubber circuit coupled in parallel with the first semiconductor switch. The RC snubber circuit may include a resistor and a capacitor coupled in series between a drain terminal and a source terminal of the first semiconductor switch. The pre-charging circuit may also include a current shunt resistor coupled between the first semiconductor switch and the first inductor. At least one of the first semiconductor switch and the second semiconductor switch may be a silicon carbide (SIC) MOSFET. An anode of the diode may be coupled to the second inductor and a cathode of the diode may be coupled to the first inductor. The diode may be a silicon carbide (SiC) diode, a Schottky barrier diode (SBD), or a silicon DQ diode. A drain terminal of the first semiconductor switch may be coupled to the first terminal of the high voltage source, and a source terminal of the first semiconductor switch may be coupled to the first inductor. A drain terminal of the second semiconductor switch may be coupled to the second inductor and an anode of the diode, and a source terminal of the second semiconductor switch may be coupled to the second terminal of the high voltage source.

According to an aspect of one or more examples there is provided a method of pre-charging a capacitor using a pre-charging circuit. The method may include driving, using a first drive signal, a first semiconductor switch coupled to a first terminal of a high voltage source and to a first terminal of the capacitor via a first inductor, and driving, using a second drive signal, a second semiconductor switch coupled to a second terminal of the high voltage source and to a second terminal of the capacitor via a second inductor. The pre-charging circuit may include a diode coupled to the first semiconductor switch, the second semiconductor switch, the first inductor, and the second inductor, and coupled in parallel with the capacitor. The steps of driving the first semiconductor switch and driving the second semiconductor switch may include driving the first semiconductor switch and driving the second conductor switch to charge the capacitor to a predetermined level. The steps of driving the first and second semiconductor switches may include driving one of the first and second semiconductor switches in a pulse width modulation (PWM) mode. The steps of driving the first and second semiconductor switches may include controlling a duty cycle or frequency of the first drive signal and the second drive signal that respectively drive the first and second semiconductor switches based on one or more of a minimum or maximum voltage value of the high voltage source, a minimum or maximum capacitance of the capacitor to be pre-charged, and a minimum or maximum inductance of the first or second inductor. At least one of the first inductor and the second inductor may be a wiring parasitic inductance. An anode of the diode may be coupled to the second inductor and a cathode of the diode may be coupled to the first inductor. The diode may be a silicon carbide (SiC) diode, a Schottky barrier diode (SBD), or a silicon DQ diode. A drain terminal of the first semiconductor switch may be coupled to the first terminal of the high voltage source, and a source terminal of the first semiconductor switch may be coupled to the first inductor. A drain terminal of the second semiconductor switch may be coupled to the second inductor and an anode of the diode, and a source terminal of the second semiconductor switch may be coupled to the second terminal of the high voltage source. The steps of driving the first and second semiconductor switches may include controlling a duty cycle or frequency of the first drive signal and the second drive signal based on a current measured by a current shunt resistor coupled between the first semiconductor switch and the first inductor during pre-charging of the capacitor. A first duty cycle of the first drive signal and a second duty cycle of the second drive signal may be fixed. The method may include increasing a first duty cycle of the first drive signal and a second duty cycle of the second drive signal in response to an increase in the amount of charge on the capacitor. The method may include measuring an output current using a current shunt resistor coupled to the first semiconductor switch, and controlling a first duty cycle of the first drive signal or a second duty cycle of the second drive signal based on the measured output current.

### BRIEF DESCRIPTION OF DRAWINGS

FIG. 1 shows a pre-charge circuit of a battery disconnect unit of an electric vehicle according to the prior art.

FIG. 2 shows a pre-charge circuit of a battery disconnect unit of an electric vehicle for pre-charging an auxiliary power module according to the prior art.

FIG. 3 shows a pre-charge circuit according to one or more examples.

### DETAILED DESCRIPTION OF VARIOUS EXAMPLES

Reference will now be made in detail to the following various examples, which are illustrated in the accompanying drawings, wherein like reference numerals refer to like elements throughout. The following examples may be embodied in various forms without being limited to the examples set forth herein.

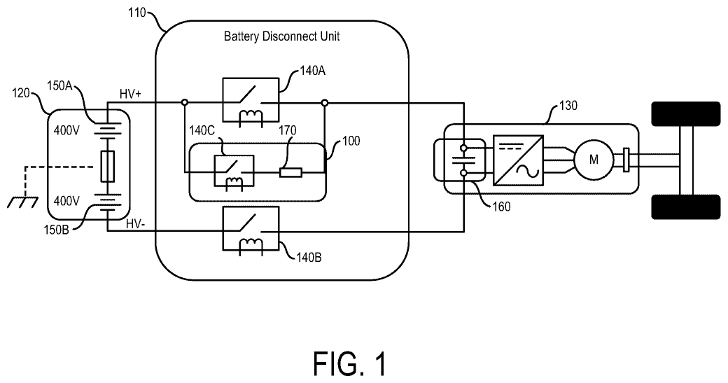

Pre-charging DC-link capacitors in high-voltage DC distribution systems can be used in a variety of applications, such as battery disconnect units (BDUs) or power distribution units (PDUs) of electric vehicles, data center PDUs, energy storage systems, and various DC distribution systems. For example, FIG. 1 shows a pre-charge circuit 100 of a battery disconnect unit 110 of an electric vehicle according to the prior art. In FIG. 1, a high voltage source 120 is coupled to an electric traction drive 130 of the vehicle via two main electromechanical switches 140A, 140B, which are included within a battery disconnect unit (BDU) 110. As shown in FIG. 1, the high voltage source 120 may be two batteries 150A, 150B coupled in series, though any number of batteries or other voltage sources may be used. The electric traction drive 130 includes a DC-link capacitor 160 that is charged before the main electromechanical switches 140A, 140B are closed to couple the high voltage source 120 to the electric traction drive 130. If the main electromechanical switches 140A, 140B are closed to couple the high voltage source 120 to the electric traction drive 130 before the DC-link capacitor 160 is charged, the DC-link capacitor 160 will act as a short circuit. To pre-charge the DC-link capacitor 160, a pre-charge circuit 100 within the BDU 110 is used. The pre-charge circuit 100 includes an electromechanical switch 140C coupled in series with a resistor 170, such as a ceramic resistor. However, electromechanical switches (e.g., the electromechanical switch 140C) can be unreliable, and the resistor 170 of the pre-charge circuit 100 adds cost and may be too large for many applications.

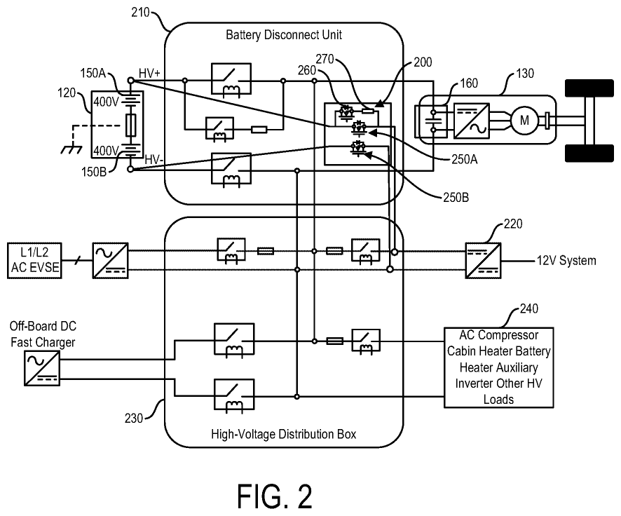

FIG. 2 shows a pre-charge circuit 200 of a battery disconnect unit 210 of an electric vehicle for pre-charging an auxiliary power module 220 according to the prior art. FIG. 2 includes a high voltage distribution box 230 that is used to provide power to various high voltage systems 240 of the electric vehicle such as an air conditioning compressor, cabin heater, battery heater, auxiliary inverter, and other high voltage loads. The high voltage distribution box 230 may also be coupled to an auxiliary power module (APM) 220, which is a DC-DC converter that provides a 12-volt source for various other loads of the electric vehicle. The APM 220 may be coupled to the high voltage batteries 150A, 150B of the high voltage source 120 via first and second APM switches 250A, 250B. For example, the first APM switch 250A may be coupled to a positive terminal of the first high voltage battery 150A of the high voltage source 120, and the second APM switch 250B may be coupled to a negative terminal of the second high voltage battery 150B of the high voltage source 120. The first high voltage battery 150A may be a 400-volt battery and the second high voltage battery 150B may also be a 400-volt battery. However, like the DC-link capacitor 160 of the electric traction drive 130 described in connection with FIG. 1, the APM 220 includes a capacitor (not shown in FIG. 2) that is pre-charged before the first and second APM switches 250A, 250B are closed to avoid the capacitor of the APM 220 acting as a short. In FIG. 2, the pre-charge circuit 200 includes a semiconductor switch 260 (here, a metal oxide semiconductor field effect transistor (MOSFET)) in series with a resistor 270. The semiconductor switch 260 may be more reliable than an electromechanical switch (e.g., the electromechanical switch 140C in FIG. 1), however the pre-charge circuit 200 still includes a resistor 270, which increases costs and may be too large for certain applications.

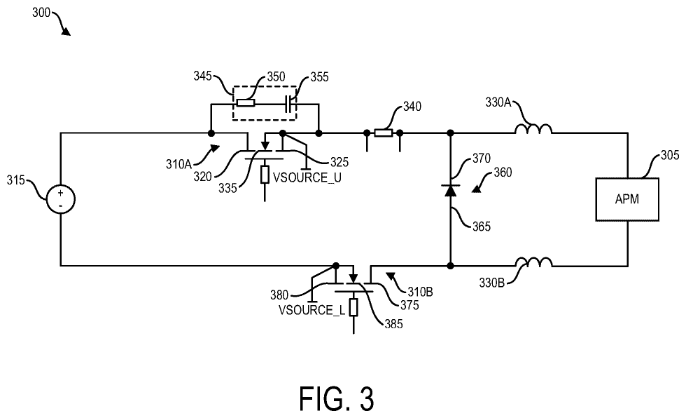

FIG. 3 shows a pre-charge circuit 300 according to one or more examples. Although the example pre-charge circuit 300 of FIG. 3 is shown for pre-charging a capacitor in an auxiliary power module (APM) 305 of an electric vehicle, the pre-charging circuit 300 is not limited to this application and can be used in various other applications to pre-charge a capacitor. The pre-charge circuit 300 of FIG. 3 may include a first semiconductor switch 310A that is coupled to a high voltage source 315, which in this example is a high voltage battery. In various examples, the high voltage source 315 is similar to the high voltage source 120 in FIGS. 1 and 2. More specifically, a drain terminal 320 of the first semiconductor switch 310 may be coupled to a positive terminal of the high voltage source 315, and a source terminal 325 of the first semiconductor switch 310A may be coupled to a first inductor 330A. The source terminal 325 and a gate terminal 335 of the first semiconductor switch 310A may be coupled to a first gate driver circuit (not shown in FIG. 3) that outputs a first gate drive signal that turns the first semiconductor switch 310A on and off. The first gate driver circuit may include a resistor coupled to the gate terminal 335 of the first semiconductor switch 310A. The first gate drive signal may be applied from a controller through a MOSFET gate driver. The first gate drive signal may or may not be isolated based on a location of the MOSFET gate driver. According to one or more examples, the pre-charge circuit 300 may include a current shunt resistor 340 coupled between the source terminal 325 of the first semiconductor switch 310 and the first inductor 330A. The current shunt resistor 340 may measure current during pre-charge and normal operation of the pre-charge circuit 300. According to one or more examples, the pre-charge circuit 300 may include an RC snubber circuit 345 coupled in parallel with the first semiconductor switch 310A. For example, the RC snubber circuit 345 may include a resistor 350 and a capacitor 355 coupled in series between the drain terminal 320 of the first semiconductor switch 310A and the source terminal 325 of the first semiconductor switch 310A. In the example shown in FIG. 3, the first semiconductor switch 310A is a silicon carbide (SiC) MOSFET, though other types of semiconductor switches can be used.

The pre-charge circuit of FIG. 3 may also include a second inductor 330B coupled to a capacitor that is to be pre-charged. In the example of FIG. 3, the pre-charge capacitor is part of the APM 305 of an electric vehicle, though other applications that pre-charge a capacitor can be used. As shown in FIG. 3, the first inductor 330A may also be coupled to the capacitor of the APM 305. The pre-charge circuit 300 may also include a diode 360 coupled in parallel to the capacitor of the APM 305, with an anode 365 of the diode 360 coupled to the second inductor 330B and a cathode 370 of the diode 360 coupled to the first inductor 330A. The diode 360 may be a SiC diode, a Schottky barrier diode (SBD), a Silicon DQ diode, or other suitable diode. The pre-charge circuit 300 may also include a second switch 310B that is coupled to the second inductor 330B and the high voltage source 315. In particular, a drain terminal 375 of the second semiconductor switch 310B may be coupled to the second inductor 330B and the anode 365 of the diode 360, and a source terminal 380 of the second semiconductor switch 310B may be coupled to a negative terminal of the high voltage source 315. The source terminal 380 of the second semiconductor switch 310B and the gate terminal 385 of the second semiconductor switch 310B may be coupled to a second gate driver circuit (not shown in FIG. 3) that outputs a second gate drive signal to turn the second semiconductor switch 310B on and off. The second gate driver circuit may include a resistor coupled to the gate terminal 385 of the second semiconductor switch 310B.

According to one or more examples, the first and second inductors 330A, 330B may be embodied as a physical inductance. According to one or more examples, the first and second inductors 330A, 330B may be embodied as wiring parasitic inductance. Referring to FIG. 3, first and second inductors 330A, 330B may be embodied as wires exhibiting a parasitic inductance to provide an inductive component that helps in pre-charging the capacitor of the APM 305. For example, when used in a battery disconnect unit (e.g., the BDU 110 in FIG. 1 or the BDU 210 in FIG. 2) of an electric vehicle, the wiring from the first and second semiconductor switches 310A, 310B to the APM 305 may have a parasitic inductance that is sufficient to use in a buck converter configuration, as shown in FIG. 3, that limits how quickly the current provided to the capacitor of the APM 305 can change. According to various examples, the parasitic inductance of the wiring may be approximately 2-10 uH, though other inductance values may be used. By using the parasitic inductance of the wiring, no physical inductor is needed. Moreover, since the parasitic inductance does not have a magnetic core, saturation is not an issue. According to one or more examples, the pre-charge circuit 300 may include a third inductor, in addition to the first and second inductors 330A, 330B.

In operation, the pre-charge circuit 300 of FIG. 3 can be controlled in multiple ways. According to various examples, the pre-charge circuit 300 may be operated in an open-loop manner based on pre-defined worst-case conditions. For example, the first and second gate driver circuits may respectively control the first and second semiconductor switches 310A, 310B in a pulse width modulation (PWM) mode. For example, in the PWM mode, the first and second gate driver circuits may output a series of pulses in a pulse train with a fixed frequency but varying width. The frequency of the PWM signal may determine how often the series of pulses in the pulse train repeats. The first and second gate driver circuits in PWM mode may control the average power delivered to a load (e.g., the capacitor of the APM 305) by varying a duty cycle, or proportion of time in which the signal is high in each cycle. More specifically, there may be multiple operating conditions. According to a first operating condition, the first semiconductor switch 310A varies duty cycle, while the second semiconductor switch 310B is kept on. According to a second operating condition, the first semiconductor switch 310A is kept on, while the second semiconductor switch 310B varies the duty cycle. According to various examples in which the pre-charge circuit 300 is operated in an open loop manner, the duty cycle or frequency of the first and second gate drive signals may be set based on one or more of a minimum or maximum voltage of the high voltage source 315, a minimum or maximum capacitance of the load (e.g., the capacitor of the APM 305 in FIG. 3), and a minimum or maximum parasitic inductance. According to various examples, the pre-charge circuit 300 may be controlled in an open loop manner by controlling the duty cycle or frequency of the first and second gate drive signals based on input conditions, such as the voltage of the high voltage source 315. According to one or more examples, the first gate driver circuit may provide a PWM signal to the first semiconductor switch 310A that controls a rate of charge of the capacitor of the APM 305. When the capacitor of the APM 305 is fully charged, the first gate drive signal may be fully on at a 100% duty cycle. The second gate driver circuit may provide a PWM signal to the second semiconductor switch 310B that is turned on during pre-charge and normal operation of the pre-charge circuit 300. The second gate drive signal may be turned off, along with the first gate drive signal, when power to the APM 305 is removed, powered down, or turned off.

According to various examples, the duty cycle of the first and second gate drive signals may be fixed so that the output current reaches a peak output current level and then subsequently decreases exponentially. According to various examples, the duty cycle of the first and second gate drive signals may be varied to maintain a substantially constant output current to the load (e.g., the capacitor of the APM 305). For example, the duty cycle of the first and second gate drive signals may begin low (e.g., the duty cycle is below 50 percent) and then increase as the amount of charge on the capacitor of the APM 305 increases. According to various examples, the pre-charge circuit 300 can be operated in a closed loop manner using the current shunt resistor 340 for current measurement. For example, the duty cycle or frequency of the first and second gate drive signals may be controlled to adjust the output current based on the current measured by the current shunt resistor 340 during pre-charging of the capacitor of the APM 305. According to various examples, the current shunt resistor 340 may be used to detect an over-current or short-circuit during pre-charging or during normal operation following pre-charging. According to various examples, the pre-charge circuit 300 of FIG. 3 may replace the pre-charge circuit 100 in FIG. 1 for pre-charging the DC-link capacitor 160 of the electric traction drive 130, and a second pre-charge circuit 300 according to FIG. 3 may be used to pre-charge the capacitor of the APM 305.

Various examples have been disclosed herein, in connection with the above description and the drawings. It will be understood that it would be unduly repetitious to literally describe and illustrate every combination and subcombination of these examples. Accordingly, all examples can be combined in any way and/or combination, and the present specification, including the drawings, shall be construed to constitute a complete written description of all combinations and subcombinations of the examples described herein, and of the manner and process of making and using them, and shall support claims to any such combination or subcombination.

It will be appreciated by persons skilled in the art that the examples described herein are not limited to what has been particularly shown and described herein above. In addition, unless mention was made above to the contrary, it should be noted that all of the accompanying drawings are not to scale. A variety of modifications and variations are possible in light of the above teachings.

What is claimed is:

1. A pre-charging circuit comprising:
a first semiconductor switch to be coupled to a first terminal of a high voltage source;
a first inductor to be coupled to the first semiconductor switch and a first terminal of a capacitor;
a second semiconductor switch to be coupled to a second terminal of the high voltage source;
a second inductor to be coupled to the second semiconductor switch and a second terminal of the capacitor; and
a diode coupled to the first semiconductor switch, the second semiconductor switch, the first inductor, and the second inductor, and coupled in parallel with the capacitor.

2. The pre-charging circuit according to claim 1, wherein at least one of the first inductor and the second inductor is a wiring parasitic inductance.

3. The pre-charging circuit according to claim 1, further comprising:
a first gate driver circuit to drive the first semiconductor switch; and
a second gate driver circuit to drive the second semiconductor switch.

4. The pre-charging circuit according to claim 1, further comprising an RC snubber circuit coupled in parallel with the first semiconductor switch.

5. The pre-charging circuit of claim 4, wherein the RC snubber circuit comprises a resistor and a capacitor coupled in series between a drain terminal and a source terminal of the first semiconductor switch.

6. The pre-charging circuit according to claim 1, further comprising a current shunt resistor coupled between the first semiconductor switch and the first inductor.

7. The pre-charging circuit of claim 1, wherein at least one of the first semiconductor switch and the second semiconductor switch is a silicon carbide (SiC) MOSFET.

8. The pre-charging circuit of claim 1, wherein an anode of the diode is coupled to the second inductor and a cathode of the diode is coupled to the first inductor.

9. The pre-charging circuit of claim 1, wherein the diode is a silicon carbide (SiC) diode, a Schottky barrier diode (SBD), or a silicon DQ diode.

10. The pre-charging circuit of claim 1, wherein a drain terminal of the first semiconductor switch is coupled to the first terminal of the high voltage source, and a source terminal of the first semiconductor switch is coupled to the first inductor.

11. The pre-charging circuit of claim 1, wherein a drain terminal of the second semiconductor switch is coupled to the second inductor and an anode of the diode, and a source terminal of the second semiconductor switch is coupled to the second terminal of the high voltage source.

12. A method of pre-charging a capacitor using a pre-charging circuit, the method comprising:
driving, using a first drive signal, a first semiconductor switch coupled to a first terminal of a high voltage source and to a first terminal of the capacitor via a first inductor; and
driving, using a second drive signal, a second semiconductor switch coupled to a second terminal of the high voltage source and to a second terminal of the capacitor via a second inductor;
wherein the pre-charging circuit includes a diode coupled to the first semiconductor switch, the second semiconductor switch, the first inductor, and the second inductor, and coupled in parallel with the capacitor; and
wherein the steps of driving the first semiconductor switch and driving the second semiconductor switch comprise driving the first semiconductor switch and driving the second conductor switch to charge the capacitor to a predetermined level.

13. The method of claim 12, wherein the driving of the first and second semiconductor switches includes driving at least one of the first and second semiconductor switches in a pulse width modulation (PWM) mode.

14. The method of claim 13, wherein the driving of the first and second semiconductor switches includes controlling a duty cycle or frequency of the first drive signal and the second drive signal that respectively drive the first and second semiconductor switches based on one or more of a minimum or maximum voltage value of the high voltage source, a minimum or maximum capacitance of the capacitor to be pre-charged, and a minimum or maximum inductance of the first or second inductor.

15. The method of claim 12, wherein at least one of the first inductor and the second inductor is a wiring parasitic inductance.

16. The method of claim 12, wherein an anode of the diode is coupled to the second inductor and a cathode of the diode is coupled to the first inductor.

17. The method of claim 12, wherein the diode is a silicon carbide (SiC) diode, a Schottky barrier diode (SBD), or a silicon DQ diode.

18. The method of claim 12, wherein a drain terminal of the first semiconductor switch is coupled to the first terminal of the high voltage source, and a source terminal of the first semiconductor switch is coupled to the first inductor.

19. The method of claim 12, wherein a drain terminal of the second semiconductor switch is coupled to the second inductor and an anode of the diode, and a source terminal of the second semiconductor switch is coupled to the second terminal of the high voltage source.

20. The method of claim 12, wherein the driving of the first and second semiconductor switches includes controlling a duty cycle or frequency of the first drive signal and the second drive signal based on a current measured by a current shunt resistor coupled between the first semiconductor switch and the first inductor during pre-charging of the capacitor.

21. The method of claim 12, wherein a first duty cycle of the first drive signal and a second duty cycle of the second drive signal are fixed.

22. The method of claim 12, comprising increasing a first duty cycle of the first drive signal and a second duty cycle of the second drive signal in response to an increase in the amount of charge on the capacitor.

23. The method of claim 12, comprising:
measuring an output current using a current shunt resistor coupled to the first semiconductor switch; and
controlling a first duty cycle of the first drive signal or a second duty cycle of the second drive signal in based on the measured output current.
